(19) United States
(12) Patent Application Publication
(10) Pub. No.: US 2024/0286846 A1
(43) Pub. Date: Aug. 29, 2024

(54) Axle or Shaft

(71) Applicant: Schindler Holding GmbH & Co KG, Pluederhausen (DE)

(72) Inventor: Jens SCHINDLER, Pluederhausen (DE)

(73) Assignee: Schindler Holding GmbH & Co KG, Pluederhausen (DE)

(21) Appl. No.: 18/584,056

(22) Filed: Feb. 22, 2024

(30) Foreign Application Priority Data
Feb. 27, 2023 (DE) 10 2023 104 701.9

(51) Int. Cl. B65G 39/073; B65G 23/04

(52) U.S. Cl. CPC B65G 39/073; B65G 23/04; B65G 2201/0202

(57) ABSTRACT

An axle or shaft has openings and/or depressions in radial direction. The recesses and/or depressions may be oriented in, or at least largely in, the longitudinal direction of the axle and may be of slot-shaped configuration or of punctiform configuration with several together oriented in the longitudinal direction of the axle.

### CROSS REFERENCE TO RELATED APPLICATIONS

Applicant claims priority under 35 U.S.C. § 119 of German Application No. 10 2023 104 701.9 filed Feb. 27, 2023, the disclosure of which is incorporated by reference.

### BACKGROUND OF THE INVENTION

### 1. Field of the Invention

The invention relates to an axle or shaft.

### 2. Description of the Related Art

These shafts are frequently used for transport belts, also in machines which process foodstuffs.

For that purpose bushes on which the transport medium is guided are often mounted on the axles or shafts.

In all applications it is, in any event, essential that the shafts can be regularly cleaned and/or serviced.

However, it is not possible with known axles or shafts to also clean the intermediate space between the axle and the bushes without laborious demounting work.

### SUMMARY OF THE INVENTION

It is therefore the object of the invention to create a possibility of also making this intermediate space capable of being cleaned even in the installed state and without demounting work.

According to the invention this object is fulfilled by the axle being provided with openings and/or depressions.

It is possible for, for example, cleaning agent to be introduced between the parts of the axles and thus the intermediate space to be cleaned.

In that case it has proved particularly advantageous if the recesses and/or depressions are oriented in longitudinal direction of the axle.

A free space which can be used for cleaning is thereby created.

An extremely advantageous embodiment of the invention is present when the recesses and/or depressions are of slot-shaped configuration.

By virtue of the slot-shaped configuration it is possible for, for example, cleaning agent to be introduced laterally. A central introduction of cleaning agent is also conceivable.

According to the invention it is also particularly advantageous embodiment if the recesses and/or depressions are of punctiform configuration, wherein several are together oriented in longitudinal direction of the axle.

A good distribution of cleaning agent, which is to be introduced, by way of the axle is thereby guaranteed.

It has proved particularly advantageous if the recesses and/or depressions are configured to be connected together.

In that case it has proved particularly advantageous if the connections lead to a common point of the axle, preferably to the end face of the axle.

A central introduction of cleaning agent can be realised by the connection.

Further, it has also proved extremely advantageous when the axle is hollow form.

It is thus possible to introduce cleaning agent by way of the hollow axle, the cleaning agent being distributed by the recesses over the axle.

Moreover it has proved particularly advantageous if at least one sleeve, which is pushed onto the axle, is provided.

The sleeve can rotate on the axle and can be used as, for example, a deflection for transport belts.

In that case it has proved very advantageous if the sleeve has a circular cross-section internally corresponding with the axle.

A good capability of rotation is thereby guaranteed.

A very advantageous development of the invention is also present when the sleeve has internally a cross-section engaging in to the axle, i.e. engaging in at least one recess and/or depression.

By virtue of a cross-section engaging in the axle it is also possible for forces, which, for example, enable drive of transport belts, to be transmitted between axle and sleeve.

In that case it has proved very advantageous if an entrainer is provided.

Such an entrainer can engage very satisfactorily in a recess and/or depression. This can be configured to be detachable.

Moreover, according to the invention it is very advantageous if the sleeve is rotatably mounted on the axle.

Smoother running of the sleeve on the axle and thus of an exemplifying transport belt is made possible by the capability of rotation.

According to the invention it is also very advantageous if with respect to its rotatability the sleeve is mounted by friction couple on the axle.

A drive can thereby be realised.

An extremely advantageous development of the invention is also present when the sleeve is displaceably mounted on the axle.

Through displacement of the sleeve on the axle not only the axle, but also the sleeve can again be better cleaned. In addition, the sleeve can be displaced on the axle depending on use. Different combinations of sleeves on an axle can be realised.

A further very advantageous development of the invention is present when a securing device for fixing the position of the sleeve on the axle is provided.

The respective sleeve is thereby held on the axle in a defined position.

In that case, according to the invention it has proved very advantageous if the securing device is provided to be detachable.

As a result the sleeve can be very easily displaced for, for example, cleaning. For that purpose the securing device is detached.

A very advantageous use in accordance with the invention of an axle according to the invention is present when the axle or shaft is provided in a transport belt as a drive axle and/or guide axle or drive shaft.

Greatest possible flexibility in this use is thereby achieved.

In that case it has proved very advantageous if the axle or shaft is provided in a plant which processes foodstuffs.

Excellent capability of cleaning is important particularly in plants of that kind. This is ensured by the shaft or axle according to the invention.

Further, it has proved very advantageous if the sleeve, the axle or the shaft is configured to be capable of cleaning primarily in an intermediate space therebetween.

It is ensured by this capability of cleaning that hygiene prescriptions for foodstuffs machines can be guaranteed.

### BRIEF DESCRIPTION OF THE DRAWINGS

The invention is illustrated in the following by way of several embodiments, in which:

FIG. 1 shows a hollow axle according to the invention with several openings extending in longitudinal direction and a sleeve mounted thereon,

FIG. 2 shows an axle according to the invention with several radial depressions extending in longitudinal direction and a sleeve mounted thereon and

FIG. 3 shows a combination of several sleeves on two axles.

### DETAILED DESCRIPTION OF PREFERRED EMBODIMENTS

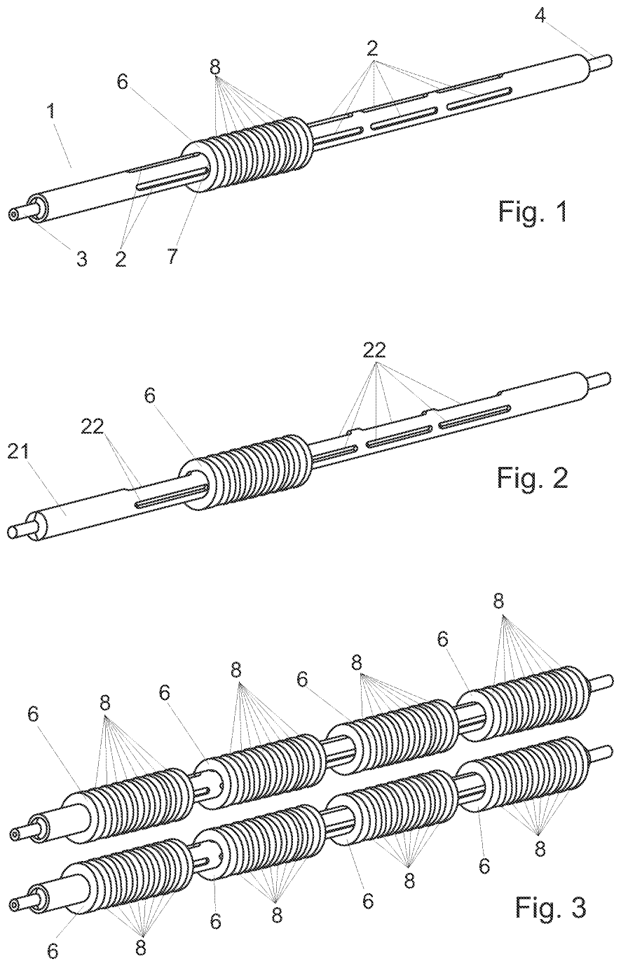

An axle which is of hollow construction is denoted by 1 in FIG. 1. Slot-shaped recesses 2 are arranged in axial direction at the circumference of the axle over approximately the entire length of the axle 1. Provided at the ends of the axle 1 are respective bearing journals 3 or 4, with the help of which the axle 1 can be rotatably or rigidly mounted in a machine arrangement.

The recesses 2 can be provided at the circumference in a multiple. Other arrangements are conceivable. It is possible, for example, that the recesses have a twisted course.

A sleeve 6 formed with a circular inner contour 7 is arranged on the axle 1. The inner contour 7 corresponds with the outer contour of the axle 1 so that the sleeve is mounted on the axle to be free of play in radial direction.

Nevertheless, the sleeve 6 is displaceable on the axle 1.

In this embodiment the outer contour of the sleeve 6 has grooves 8, which extend over the circumference, for reception of transport belts.

Thus, overall not only can the axle 1 can rotate in its bearing, but also the sleeve 6 can rotate on the axle 1.

If a machine equipped with such an axle is now to be cleaned, it is on the one hand a simple matter to also apply cleaning agent to the inner side of the inner contour 7 of the sleeve 6 via the recesses 2. This is usually carried out by spraying. It is equally conceivable for cleaning agent to be introduced through the hollow shaft and then wet the inner contour 7 of the sleeves over the entire axial length by way of the recesses 2.

In addition, the sleeve 6 can be displaced on the axle 1 in axial direction so that every area of the axle is accessible and cleanable.

In order to prevent undesired displacement of the sleeve 6 on the axle 1 it is conceivable to provide appropriate securing. This can be, for example, a clamping ring on the axle. A device at the machine side is also conceivable here. Thus, for example, there can be provided on the machine side a form of dog which engages the axial ends of the sleeve or also in the grooves and thus prevents displacement. Such a dog can, for example, be capable of being tilted away or taken off.

Alternatively it is conceivable, as illustrated in FIG. 2, that a solid axle 21 is provided, which has along its circumference slot-shaped depressions 22 oriented in longitudinal direction. Cleaning agent can also be introduced via these depressions. The depressions 22 can, for example, be connected together by channels so that here too a central introduction of cleaning agent is conceivable.

However, the design of the axles in accordance with the invention also enables selectable use as shafts which can transmit torque to transport belts.

For that purpose the sleeves 6 are equipped with an entrainer (not illustrated) capable of engaging in the recesses 2 or depressions 22. In the simplest case this entrainer is a screw, a split pin or the like.

Torque is thereby transmitted between the shaft 1 or 21 and the sleeve 6.

Here, too, cleaning agent can also be applied to the inner side 7 of the sleeve 6. Through displacing the sleeve 6, the shaft 1 as well as the inner side of the sleeve 6 can be very satisfactorily cleaned.

An axle shaft which can serve not only as a deflection, but also at the same time as a drive, can be created by appropriate combination of sleeves 6 with and without entrainers.

Even different speeds of the deflection and the drive are conceivable.

The configuration of such an axle shaft also does not have to be fixed beforehand. The configuration is determined exclusively by the appropriate combination of sleeves 6 with and without entrainers. For that purpose the axle shafts as well as the sleeves 6 are provided as standard parts and are then appropriately configured in correspondence with the respective purpose of use.

An exemplifying configuration is shown in FIG. 3.

An axle shaft pair which is both drive shaft and deflecting axle is shown here.

Different embodiments of the individual sleeves 6, for example with respect to the outer surface thereof, the provided grooves 8 or the like, are conceivable.

Overall a very satisfactorily cleanable and very flexibly usable system which can guarantee the appropriate hygiene requirements particularly in foodstuffs machines is created.

The axles can be produced by known joining methods. Thus, the individual parts can be joined together by welding, soldering, laser welding, glueing, screwing or the like. The recesses 2 or the depressions 22 can be produced by classic material removal or, however, by laser cutting or the like.

1: An axle (1) or shaft, wherein the axle (1) is provided with openings (2) and/or depressions (22) in radial direction.

2: The axle according to claim 1, wherein the recesses (2) and/or depressions (22) are oriented at least largely in longitudinal direction or in longitudinal direction of the axle (1).

3: The axle according to claim 1, wherein the recesses (2) and/or depressions (22) are of slot-shaped configuration.

4: The axle according to claim 1, wherein the recesses (2) and/or depressions (22) are of punctiform configuration, wherein several are together oriented in longitudinal direction of the axle (1).

5: The axle according to claim 1, wherein the recesses (2) and/or depressions (22) are configured to be connected together.

6: The axle according to claim 5, wherein the connections lead to a common point of the axle, preferably to the end face of the axle.

7: The axle according to claim 1, wherein the axle (1) is of hollow form.

8: The axle according to claim 1, wherein at least one sleeve (6), which is pushed onto the axle (1), is provided.

9: The axle according to claim 1, wherein the sleeve (6) has a circular cross-section internally corresponding with the axle (1).

10: The axle according to claim 1, wherein the sleeve (6) has internally a cross-section engaging in the axle (1), i.e. in at least one recess (2) and/or depression (22).

11: The axle according to claim 10, wherein an entrainer is provided.

12: The axle according to claim 1, wherein the sleeve (6) is rotatably mounted on the axle (1).

13: The axle according to claim 1, wherein with respect to its rotatability the sleeve (6) is mounted by friction couple on the axle (1).

14: The axle according to claim 1, wherein the sleeve (6) is displaceably mounted on the axle (1).

15: The axle according to claim 1, wherein a securing device for fixing the position of the sleeve (6) on the axle (1) is provided.

16: The axle according to claim 15, wherein the securing device is provided to be detachable.

17: A transport belt comprising the axle or shaft according to claim 1, wherein the axle (1) or shaft is a drive axle and/or a guide axle or a drive shaft.

18: A plant which processes foodstuffs comprising the transport belt according to claim 17.

19: The transport belt according to claim 17, wherein the sleeve (6), the axle or the shaft is configured to be capable of cleaning primarily in an intermediate space therebetween.
